(19) United States
(12) Patent Application Publication
(10) Pub. No.: US 2007/0234471 A1
(43) Pub. Date: Oct. 11, 2007

(54) Child toilet trainer

(76) Inventors: Kimburlee Walker, St. Joseph, MO (US); Brian Walker, St. Joseph, MO (US)

Correspondence Address: JAMES RAY & ASSOCIATES, 2640 PITCAIRN ROAD, MONROEVILLE, PA, 15146, US

(21) Appl. No.: 11/398,367

(22) Filed: Apr. 5, 2006

(51) Int. Cl. E03D 9/00; F15D 1/00

(52) U.S. Cl. 4/300.3

(57) ABSTRACT

An apparatus to protect areas adjacent a toilet bowl when training young children to go to the potty by themselves. Such apparatus includes a generally cylindrically shaped member to be positioned above and in engagement with a top portion of one of a toilet bowl and a toilet bowl seat. There is a generally C-shaped member formed integrally with and extending upwardly from the generally cylindrically shaped member while leaving a front portion open for a child to stand against and in front of such toilet bowl and a mechanism is provided which is one of engageable with and secured to a portion of at least one of such generally cylindrically shaped member and such generally C-shaped member for preventing the apparatus from shifting during use.

### FIELD OF THE INVENTION

The present invention relates, in general, to toilet training of small children and, more particularly, to toilet training for male children and, still more specifically, this invention relates to an apparatus for toilet training children which will substantially minimize undesirable urine splashes outside the toilet stool.

### BACKGROUND OF THE INVENTION

Prior to the conception and development of the present invention, as is generally well known in the art, when teaching a small child to use the toilet it is oftentimes the case where an accident occurs in which the toilet bowl is missed and the urine is sprayed over the area surrounding the toilet stool. This situation is not only a chore to clean up but it is also unsanitary.

Known in the prior art are potty chairs having a shield attached to the front of the chair so that as a male child urinates it hits the shield as for the most part the urine is directed into the pot. However, this is not totally satisfactory in that accidents can still occur.

Furthermore, when a child misses the toilet seat it can possibly lead to a lack of confidence and may even result in the child regressing into not telling the parent when they need to go to the bathroom.

### SUMMARY OF THE INVENTION

The present invention provides an apparatus which will assist in the potty training of small children, The apparatus further protects areas adjacent a toilet bowl when training young children to go to the potty by themselves. Such apparatus includes a generally cylindrically shaped member to be positioned above and in engagement with a top portion of one of a toilet bowl and a toilet bowl seat. A generally C-shaped member is formed integrally with and extends upwardly from such generally cylindrically shaped member while leaving a front portion open for a child to stand against adjacent a front of such toilet bowl. Additionally, there is a means one of engageable with and secured to a portion of at least one of such generally cylindrically shaped member and the generally C-shaped member for preventing such apparatus from shifting during use.

### OBJECTS OF THE INVENTION

It is, therefore, one of the primary objects of the present invention to provide an apparatus for use on a toilet stool which will substantially minimize urine splashes onto undesirable places.

Another object of the present invention is to provide an apparatus which is simple to install and remove onto and from, respectively, existing toilet bowl rims.

Still another object of the present invention is to provide an apparatus which is relatively inexpensive to manufacture.

Yet another object of the present invention is to provide an apparatus which can be produced in a variety of colors to match the décor of a person's bathroom.

A further object of the present invention is to provide an apparatus which can be made from a variety of materials.

It is an additional object of the present invention to provide an apparatus which is easy to clean.

In addition to the several objects and advantages of the invention which have been described with some degree of specificity above, it should be noted that various other objects and advantages of the present invention will become more readily apparent to those persons who are skilled in the relevant art from the following more detailed description of the invention, particularly, when such description is taken in conjunction with the attached drawing Figures and with the appended claims.

### BRIEF DESCRIPTION OF THE DRAWING FIGURES

FIG. 1 is a top view of a presently preferred embodiment of the invention; and

FIG. 2 is a front view of the apparatus illustrated in FIG. 1.

### BRIEF DESCRIPTION OF A PRESENTLY PREFERRED AND VARIOUS ALTERNATIVE EMBODIMENTS OF THE INVENTION

Prior to proceeding to the more detailed description of the invention it should be noted that, for the sake of clarity and understanding of the invention, identical components having identical functions have been identified with identical reference numerals throughout the several views illustrated in the drawing Figures.

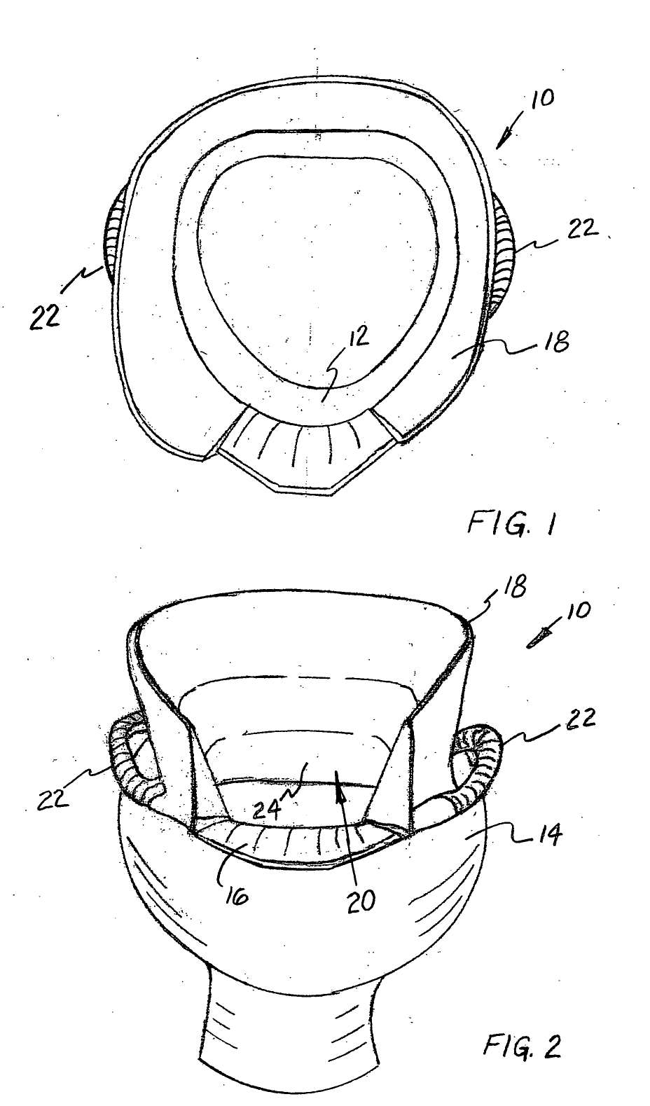

Now refer more particularly to FIGS. 1 and 2. Illustrated therein is an apparatus, generally designated 10, for assisting in the potty training of a young child, particularly a male child. Such apparatus 10 includes a generally cylindrically shaped member 12 to be positioned above and in engagement with a top portion of one of a toilet bowl 14 and a toilet bowl seat 16.

A generally C-shaped member 18 is formed integrally with and extending upwardly from the generally cylindrically shaped member 12 while leaving a front portion open for a child to stand against and in front of such toilet bowl 14 during use.

A means, generally designated 20, is one of engageable with and secured to a portion of at least one of such generally cylindrically shaped member 12 and such generally C-shaped member 18 for preventing the apparatus 10 from shifting during use.

The means 20 for preventing such apparatus 10 from shifting during use can, although not presently preferred, include a pair of handles 22 disposed on radially opposed sides of the apparatus 10.

In the presently preferred embodiment of the invention the apparatus 10 further includes a flange like member 24 attached to and depending downwardly from an inner surface of one of such generally cylindrically shaped member 12 and such generally C-shaped member 18. The flange like member 24 assisting in preventing apparatus 10 from shifting during such use.

Additionally, in the presently preferred embodiment, the apparatus 10 will be manufactured as a single piece unit from one of a preselected plastic and rubber. Preferably, such apparatus 10 is manufactured from such preselected plastic which can be blow molded and can have a variety of colors to match a décor of a bathroom.

Finally, in the presently preferred embodiment of the invention, the generally C-shaped member 18 formed integrally with and extending upwardly from such generally cylindrically shaped member 12 while leaving a front portion open for a child to stand against and in front of such toilet bowl during use is generally triangular in cross section.

While in accordance with the patent statues both a presently preferred and various alternatives embodiments of the present invention have been described above it should be understood that various other modifications and adaptations of the invention can be envisioned by those persons skilled in the art without departing from either the spirit of the invention or the scope of the appended claims.

I claim:

1. An apparatus to protect areas adjacent a toilet bowl when training young children to go potty by themselves, said apparatus comprising:
(a) a generally cylindrically shaped member positioned above and in engagement with a top portion of one of a toilet bowl and a toilet bowl seat;
(b) a generally C-shaped member formed integrally with and extending upwardly from said generally cylindrically shaped member while leaving a front portion open for a child to stand against and in front of such toilet bowl; and
(c) a means one of engageable with and secured to a portion of at least one of said generally cylindrically shaped member and said generally C-shaped member for preventing said apparatus from shifting during use, said means includes a flange like member attached to and depending downwardly from an inner surface of one of said generally cylindrically shaped member and said generally C-shaped member, said flange like member assisting in preventing said apparatus from shifting during such use.

2. (canceled)

3. (canceled)

4. The apparatus, according to claim 1, wherein said apparatus is formed as a an integral single piece.

5. The apparatus, according to claim 4, wherein said apparatus is manufactured from one of a preselected plastic and rubber.

6. The apparatus, according to claim 5, wherein said apparatus is manufactured from said preselected plastic.

7. The apparatus, according to claim 6, wherein said preselected plastic is selected from a variety of colors to match a décor of a bathroom.

8. The apparatus, according to claim 6, wherein said apparatus is blow molded.

9. The apparatus, according to claim 1, wherein said generally C-shaped member formed integrally with and extending upwardly from said generally cylindrically shaped member while leaving a front portion open for a child to stand against and in front of such toilet bowl during use is generally triangular in cross section.
